(19) United States
(12) Patent Application Publication
(10) Pub. No.: US 2026/0299325 A1
(43) Pub. Date: Oct. 1, 2026

(54) OPTICAL SEMICONDUCTOR DEVICE, SEMICONDUCTOR ELEMENT, AND METHOD FOR MANUFACTURING OPTICAL SEMICONDUCTOR DEVICE

(71) Applicant: SUMITOMO ELECTRIC DEVICE INNOVATIONS, INC., Yokohama-shi (JP)

(72) Inventor: Arashi YUI, Yokohama-shi (JP)

(73) Assignee: SUMITOMO ELECTRIC DEVICE INNOVATIONS, INC., Yokohama-shi (JP)

(21) Appl. No.: 19/559,624

(22) Filed: Mar. 6, 2026

(30) Foreign Application Priority Data
Mar. 28, 2025 (JP) 2025-055526

(51) Int. Cl. G02F 1/015

(52) U.S. Cl. CPC G02F 1/0155

(57) ABSTRACT

An optical semiconductor device includes an optical modulator having an electrode pad, a first pad spaced apart from the optical modulator, a second pad spaced apart from the optical modulator and provided opposite to the first pad with respect to the optical modulator, and a bonding wire connected from the first pad to the electrode pad and continuously connected from the electrode pad to the second pad. The bonding wire is in contact with a surface of the electrode pad in a connection region on the surface of the electrode pad. The connection region is disposed closer to an end of the electrode pad near the first pad than to an end of the electrode pad near the second pad.

### CROSS REFERENCE TO RELATED APPLICATIONS

This application claims priority based on Japanese Patent Application No. 2025-055526 filed on March 28, 2025, and the entire contents of the Japanese patent application are incorporated herein by reference.

### TECHNICAL FIELD

The present disclosure relates to an optical semiconductor device, a semiconductor element, and a method for manufacturing an optical semiconductor device.

### BACKGROUND

A device in which a semiconductor laser element and an optical modulator are integrated has been developed (for example, Patent Literature 1: Japanese Unexamined Patent Application Publication No. 2003-298175). The optical modulator is provided with an electrode for inputting a modulation signal (for example, Patent Literature 2: Japanese Unexamined Patent Application Publication No. 2004-055688). A bonding wire is connected to the electrode (for example, Patent Literature 3: Japanese Unexamined Patent Application Publication No. 2002-171020).

### SUMMARY

An optical semiconductor device according to the present disclosure includes an optical modulator having an electrode pad, a first pad spaced apart from the optical modulator, a second pad spaced apart from the optical modulator and provided opposite to the first pad with respect to the optical modulator, and a bonding wire connected from the first pad to the electrode pad and continuously connected from the electrode pad to the second pad. The bonding wire is in contact with a surface of the electrode pad in a connection region on the surface of the electrode pad. The connection region is disposed closer to an end of the electrode pad near the first pad than to an end of the electrode pad near the second pad.

### BRIEF DESCRIPTION OF THE DRAWINGS

FIG. 1 is a plan view illustrating an optical semiconductor device according to a first embodiment.

FIG. 2 is a cross-sectional view illustrating an optical semiconductor device

FIG. 3A is a cross-sectional view illustrating an optical modulator.

FIG. 3B is a cross-sectional view illustrating an optical modulator.

FIG. 4A is a plan view illustrating an electrode pad.

FIG. 4B is a cross-sectional view illustrating an electrode pad.

FIG. 5A is a top view illustrating a method for manufacturing an optical semiconductor device.

FIG. 5B is a top view illustrating a method for manufacturing an optical semiconductor device.

FIG. 5C is a top view illustrating a method for manufacturing an optical semiconductor device.

FIG. 5D is a top view illustrating a method for manufacturing an optical semiconductor device.

FIG. 6A is a top view illustrating a method for manufacturing an optical semiconductor device.

FIG. 6B is a top view illustrating a method for manufacturing an optical semiconductor device.

FIG. 6C is a top view illustrating a method for manufacturing an optical semiconductor device.

FIG. 6D is a top view illustrating a method for manufacturing an optical semiconductor device.

FIG. 7A is a top view illustrating a method for manufacturing an optical semiconductor device.

FIG. 7B is a top view illustrating a method for manufacturing an optical semiconductor device.

FIG. 7C is a top view illustrating a method for manufacturing an optical semiconductor device.

FIG. 7D is a top view illustrating a method for manufacturing an optical semiconductor device.

FIG. 7E is a top view illustrating a method for manufacturing an optical semiconductor device.

FIG. 8 is a top view illustrating a method for manufacturing an optical semiconductor device.

FIG. 9 is a top view illustrating a method for manufacturing an optical semiconductor device.

FIG. 10 is a top view illustrating a method for manufacturing an optical semiconductor device.

FIG. 11A is a plan view illustrating a bonding process.

FIG. 11B is a cross-sectional view illustrating a bonding process.

FIG. 12A is a plan view illustrating an electrode pad of an optical semiconductor device according to a second embodiment.

FIG. 12B is a cross-sectional view illustrating an electrode pad.

FIG. 13A is a diagram illustrating an evaluation result.

FIG. 13B is a diagram illustrating an evaluation result.

FIG. 14 is a plan view illustrating an optical semiconductor device according to a third embodiment.

FIG. 15 is a plan view illustrating an optical semiconductor device according to a fourth embodiment.

### DESCRIPTION OF EMBODIMENTS

In the wire bonding process, a force is applied to the electrode, and the electrode may be peeled off. The strength may be increased by enlarging the electrode. However, enlarging the electrode increases the capacitance, which makes it difficult to achieve high-speed operation. Thus, an object of the present disclosure is to provide an optical semiconductor device, a semiconductor element, and a method for manufacturing an optical semiconductor device, that have high electrode strength and low capacitance.

According to the present disclosure, it is possible to provide an optical semiconductor device, a semiconductor element, and a method for manufacturing an optical semiconductor device, that have high electrode strength and low capacitance.

### Description of Embodiments of Present Disclosure

The contents of the embodiments of the present disclosure will be listed and described first.
(1) An optical semiconductor device according to an aspect of the present disclosure includes an optical modulator having an electrode pad, a first pad spaced apart from the optical modulator, a second pad spaced apart from the optical modulator and provided opposite to the first pad with respect to the optical modulator, and a bonding wire connected from the first pad to the electrode pad and continuously connected from the electrode pad to the second pad. The bonding wire is in contact with a surface of the electrode pad in a connection region on the surface of the electrode pad. The connection region is disposed closer to an end of the electrode pad near the first pad than to an end of the electrode pad near the second pad. When the second bonding wire is extended from the electrode pad, an upward force is applied to the electrode pad. By offsetting the connection region to a position near the first pad, the strength of the electrode pad is increased, and the electrode pad is less likely to peel off. Since it is not necessary to enlarge the electrode pads, the capacitance may be reduced.
(2) In the above (1), the electrode pad is provided on a semiconductor substrate and may include a first metal layer and a second metal layer. The second metal layer may be stacked on a surface of the first metal layer. A center of one side of the second metal layer may be shifted either closer to or farther from one end of the semiconductor substrate than a center of one side of the first metal layer. The connection region may be disposed on a surface of the second metal layer. The strength of the electrode pad is increased, and the first metal layer is less likely to peel off.
(3) In the above (2), a distance between an end of the second metal layer closer to the first pad and an end of the first metal layer closer to the first pad may be shorter than a distance between an end of the second metal layer closer to the second pad and an end of the first metal layer closer to the second pad. By connecting the bonding wire using the second metal layer as a marker, the position of connection is offset toward the first pad. The strength of the electrode pad is increased. Alignment is easy in the wire bonding process.
(4) In any one of the above (1) to (3) described above, the optical modulator may include a light absorption layer that absorbs an input light in response to being provided with a potential, and a stripe electrode that is connected to the electrode pad, is provided between the electrode pad and the first pad, and provides the potential to the light absorption layer. The optical modulator operates stably.
(5) A semiconductor element includes a semiconductor substrate, a first electrode pad provided on the semiconductor substrate, and a second electrode pad provided on the first electrode pad, the second electrode pad having one side shorter than one side of the first electrode pad. A center of the one side of the second electrode pad is shifted either closer to or farther from one end of the semiconductor substrate than a center of the one side of the first electrode pad. The first electrode pad and the second electrode pad are less likely to peel off. Since it is not necessary to enlarge the first electrode pad and the second electrode pad, the capacitance may be reduced.
(6) A method for manufacturing an optical semiconductor device includes connecting a first bonding wire to an electrode pad of an optical modulator and a first pad spaced apart from the optical modulator, and after the connecting the first bonding wire, connecting a second bonding wire to the electrode pad and a second pad, the second pad being spaced apart from the optical modulator and being provided opposite to the first pad with respect to the optical modulator. The connecting the first bonding wire and the connecting the second bonding wire are performed continuously. Each of the first bonding wire and the second bonding wire is bonded to a connection region on a surface of the electrode pad with a pressure bonding tool and is in contact with the connection region. The connection region is closer to an end of the electrode pad near the first pad than to an end of the electrode pad near the second pad. By offsetting the connection region to a position near the first pad, the strength of the electrode pad is increased, and the electrode pad is less likely to peel off. Since it is not necessary to enlarge the electrode pads, the capacitance may be reduced.
(7) In the above (6), each of the connecting the first bonding wire and the connecting the second bonding wire may include connecting by stitch bonding. The strength of the electrode pad is increased, and the electrode pad is less likely to peel off.

### Details of Embodiments of Present Disclosure

Specific examples of an optical semiconductor device, a semiconductor element, and a method for manufacturing an optical semiconductor device according to an embodiment of the present disclosure will be described below with reference to the drawings. The present disclosure is not limited to these examples, but is defined by the scope of the claims, and is intended to include all modifications within the scope and meaning equivalent to the scope of the claims.

### First Embodiment

### Optical Semiconductor Device

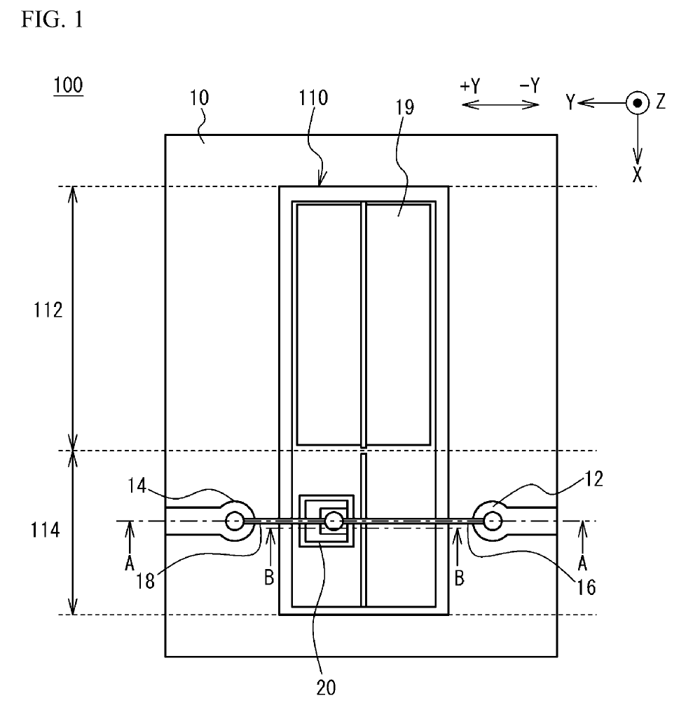

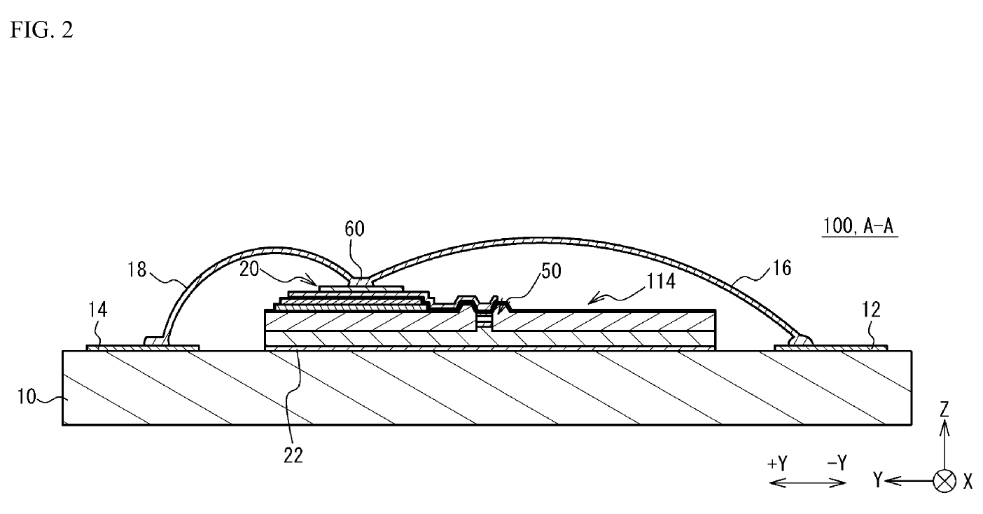

FIG. 1 is a plan view illustrating an optical semiconductor device 100 according to a first embodiment. FIG. 2 is a cross-sectional view illustrating the optical semiconductor device 100, and shows a cross section at a position of the line A-A of FIG. 1. The optical semiconductor device 100 includes a substrate 10, a pad 12 (first pad), a pad 14 (second pad), a bonding wire 16 (first bonding wire), a bonding wire 18 (second bonding wire), and a semiconductor element 110. The pad 12 and the pad 14 are provided on one surface of the substrate 10, and the semiconductor element 110 is mounted thereon. The pad 12 and the pad 14 are formed of a metal such as gold (Au). The bonding wire 16 and the bonding wire 18 are formed of a metal such as Au.

As illustrated in FIG. 1, the semiconductor element 110 is an electro-absorption modulator laser diode (EML), and includes a laser unit 112 and an optical modulator 114. The laser unit 112 and the optical modulator 114 are integrated on a single chip. Dotted lines in FIG. 1 are virtual lines illustrating the range of the laser unit 112 and the range of the optical modulator 114. The laser unit 112 has an electrode pad 19. The optical modulator 114 has an electrode pad 20. The electrode pad 19 and the electrode pad 20 are provided on the upper surface of the semiconductor element 110.

The laser unit 112 and the optical modulator 114 are optically coupled to each other and arranged in the X-axis direction. The Y-axis direction is a width direction of the semiconductor element 110. The Z-axis direction is a thickness direction and is parallel to a normal line of an upper surface of the semiconductor element 110. The X-axis direction, the Y-axis direction, and the Z-axis direction are orthogonal to each other.

One direction along the Y axis is defined as a positive Y direction. The direction opposite to the positive Y direction is defined as a negative Y direction. The pad 12 is provided at a position spaced apart from the semiconductor element 110 and on the negative Y side of the semiconductor element 110. The pad 14 is provided at a position spaced apart from the semiconductor element 110 and on the positive Y side of the semiconductor element 110.

As illustrated in FIGS. 1 and 2 , the pad 12, the electrode pad 20 of the optical modulator 114, and the pad 14 are arranged in this order in the Y-axis direction. The bonding wire 16 extends in the Y-axis direction and is connected to the pad 12 and the electrode pad 20. The bonding wire 18 extends in the Y-axis direction and is connected to the pad 14 and the electrode pad 20. The bonding wire 16 and the bonding wire 18 are connected to the same position (connection region) in the electrode pad 20. Balls are formed at a position of the electrode pad 20 to which the bonding wire is bonded and a position of the pad to which the bonding wire is bonded. In the YZ plane, the bonding wire 16 and the bonding wire 18 have a curved shape that is convex upward.

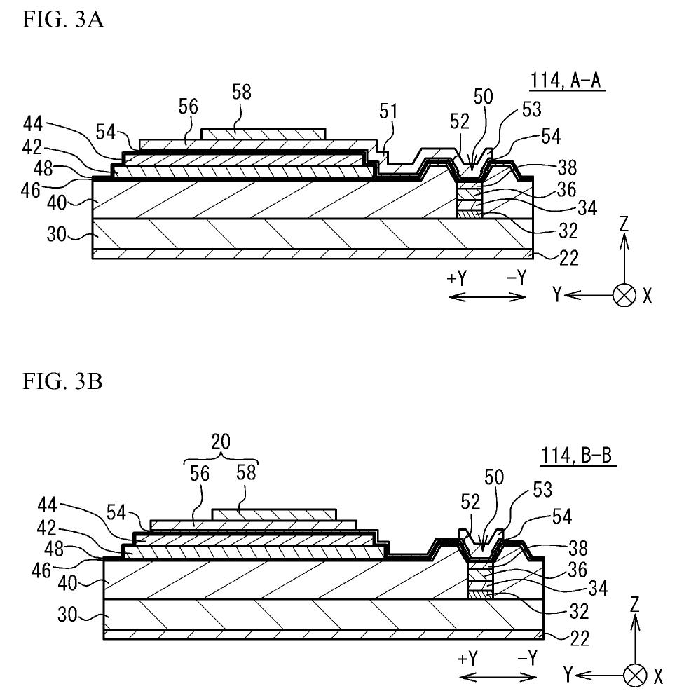

FIGS. 3A and 3B are cross-sectional views illustrating the optical modulator 114. FIG. 3A shows a cross-section along the line A-A of FIG. 1. FIG. 3B shows a cross-section along the line B-B of FIG. 1. The bonding wire is omitted.

As illustrated in FIGS. 3A and 3B, the optical modulator 114 includes a substrate 30, a cladding layer 32, a light absorption layer 34, a cladding layer 36, a contact layer 38, an embedding layer 40, a resin layer 42, a resin layer 44, an insulating film 46, an insulating film 48, the electrode pad 20, and an electrode 22. The electrode 22 is provided on the back surface of the substrate 30 and is in contact with the upper surface of the substrate 10.

A mesa 50 is provided on the surface of the substrate 30 opposite to the electrode 22. The mesa 50 protrudes from the upper surface of the substrate 30 in the Z-axis direction. The mesa 50 includes the cladding layer 32, the light absorption layer 34, the cladding layer 36, and the contact layer 38. The cladding layer 32, the light absorption layer 34, the cladding layer 36, and the contact layer 38 are stacked in this order in the Z-axis direction. The embedding layer 40 is provided on both sides of the mesa 50 in the Y-axis direction.

The substrate 10 is, for example, a semiconductor substrate, and is formed of indium phosphide (InP). The cladding layer 32 is formed of, for example, n-type indium phosphide (n-InP). The light absorption layer 34 is formed of, for example, indium gallium arsenide (InGaAs). The cladding layer 36 is formed of, for example, p-type indium phosphide (p-InP). The contact layer 38 is formed of, for example, p-InGaAs. The embedding layer 40 is formed of, for example, semi-insulating InP.

The insulating film 46 covers the surface of the embedding layer 40. The resin layer 42 and the resin layer 44 are sequentially stacked on the upper surface of the insulating film 46 at a position away from the mesa 50 in the positive Y direction. The width of the resin layer 42 is larger than the width of the resin layer 44. The insulating film 48 covers the surface of the insulating film 46, the surface of the resin layer 42, and the surface of the resin layer 44. The insulating film 46 and the insulating film 48 are not provided on the mesa 50.

The resin layer 42 and the resin layer 44 are formed of, for example, benzocyclobutene (BCB) or polyimide. The thickness of each of the resin layer 42 and the resin layer 44 is, for example, 1 μm to 4 μm. The insulating film 46 and the insulating film 48 are formed of, for example, silicon oxide (SiO₂) or silicon nitride (SiN). The thickness of each of the insulating film 46 and the insulating film 48 is, for example, 10 nm to 100 nm.

An adhesion layer 52 is provided on the mesa 50 and on the upper surface of the contact layer 38. A seed metal layer 54 is provided on the upper surface of the adhesion layer 52 and the surface of the insulating film 48, and extends from the top of the mesa 50 to the top of the resin layer 42 and the resin layer 44. A metal layer 56 (first metal layer, first electrode pad) and a metal layer 58 (second metal layer, second electrode pad) are sequentially stacked on the upper surface of the seed metal layer 54. The adhesion layer 52 is formed of a metal such as an alloy of titanium and tungsten (TiW). The seed metal layer 54 is formed of, for example, gold (Au). The metal layer 56 and the metal layer 58 are formed of, for example, Au. The thickness of the metal layer 56 is, for example, 1 μm to 4 μm. The thickness of the metal layer 58 is, for example, 1 μm to 4 μm.

As illustrated in FIG. 3A, the metal layer 56 extends from the resin layer 44 to the mesa 50. A portion of the metal layer 56 between the metal layer 58 and the mesa 50 functions as a wiring 51. A portion of the metal layer 56 located on the mesa 50 functions as a stripe electrode 53. As illustrated in FIG. 3B, the electrode pad 20 includes the metal layer 56 and the metal layer 58. The electrode pad 20, the pad 12, and the pad 14 are electrically connected to the stripe electrode 53. The light propagates through the mesa 50. A potential is provided to the light absorption layer 34 through the stripe electrode 53. By providing the potential, the light absorption layer 34 absorbs the input light.

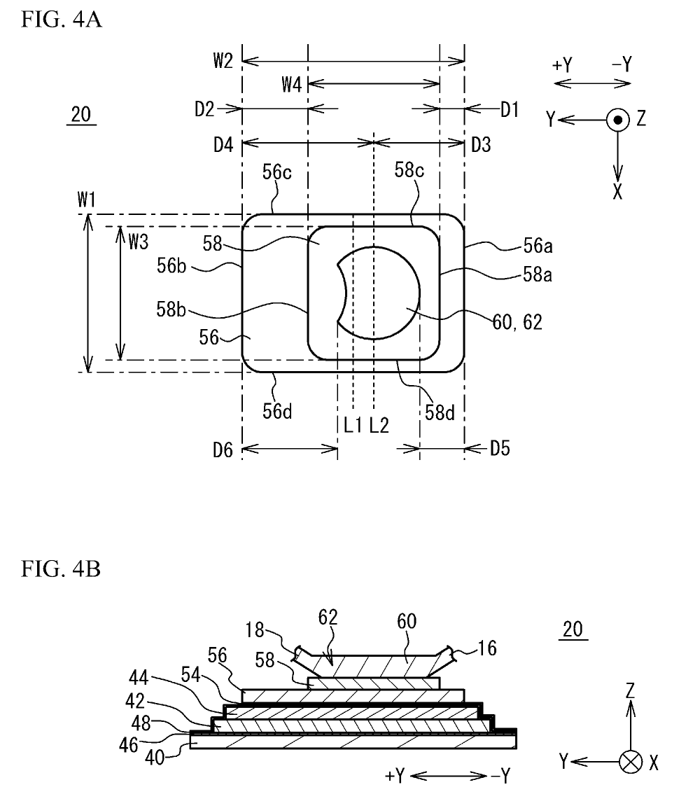

FIG. 4A is a plan view illustrating the electrode pad 20. FIG. 4B is a cross-sectional view illustrating the electrode pad 20. When the bonding wire is connected to the electrode pad 20, a ball 60 is formed on the surface of the electrode pad 20. The upper surface of the ball 60 is flattened by a pressure bonding tool. The ball 60 is, for example, an asymmetric cylindrical shape. A portion of the surface of the electrode pad 20 to which the bonding wire is connected and the bonding wire is pressure-bonded in a range where the ball 60 is formed is referred to as a connection region 62. The connection region 62 is a range where the ball 60 exists, and is a region where the ball 60 is connected to the surface of the electrode pad 20. The ball 60 is asymmetric between the direction (positive Y direction) in which the bonding wire 16 is connected from the pad 12 to the electrode pad 20 and the direction (negative Y direction) in which the bonding wire 18 is connected from the pad 14 to the electrode pad 20. Specifically, the ball 60 has a recess in the direction of the bonding wire 18 of the electrode pad 20 (positive Y direction). The connection region 62 is located on the surface of the metal layer 58.

The upper surfaces of the metal layer 56 and the metal layer 58 are parallel to an XY plane. The planar shape of the metal layer 56 and the metal layer 58 is rectangular. A width W1 of the metal layer 56 in the X-axis direction is, for example, 70 μm, and a width W2 in the Y-axis direction is, for example, 90 μm. A width W3 of the metal layer 58 in the X-axis direction is, for example, 60 μm, and a width W4 in the Y-axis direction is, for example, 50 μm. The width W3 of the metal layer 58 is smaller than the width W1 of the metal layer 56. The width W4 of the metal layer 58 is smaller than the width W2 of the metal layer 56. The end of the metal layer 58 is located inside the end of the metal layer 56.

The metal layer 56 has two ends 56a (first end) and 56b (second end) that are parallel to the X-axis, as well as two ends 56c and 56d that are parallel to the Y-axis. The metal layer 58 has two ends 58a (third end) and 58b (fourth end) that are parallel to the X-axis, as well as two ends 58c and 58d that are parallel to the Y-axis. The end 56a is located on the negative Y side and is closer to the pad 12 than the end 56b. The end 56b is located on the positive Y side and is closer to the pad 14 than the end 56a. The end 58a is located on the negative Y side and is closer to the pad 12 than the end 58b. The end 58b is located on the positive Y side and is closer to the pad 14 than the end 58a. A distance D1 between the end 56a and the end 58a is, for example, 10 μm. A distance D2 between the end 56b and the end 58b is, for example, 30 μm. The distance D1 is smaller than the distance D2.

A line L1 in FIG. 4A represents the center of the metal layer 56 in the Y-axis direction. A line L2 represents the center of the connection region 62 in the Y-axis direction. The center of the connection region 62 is shifted from the center of the metal layer 56 in the negative Y direction.

The metal layer 58 is far from the positive Y side of the end 56b of the metal layer 56 and is close to the negative Y side of the end 56a. That is, the metal layer 58 is provided at a position offset from the center of the metal layer 56 in the negative Y direction. Since the connection region 62 is located substantially at the center of the metal layer 58, the connection region 62 is formed at a position offset from the center of the metal layer 56 in the negative Y direction, similarly to the metal layer 58. In the Y-axis direction, a distance D3 between the center of the connection region 62 to the end 56a of the metal layer 56 is smaller than a distance D4 between the center of the connection region 62 to the end 56b.

A distance between the end of the connection region 62 to the end 56a of the electrode pad 20 is denoted by D5. A distance between the end of the connection region 62 to the end 56b of the electrode pad 20 is denoted by D6. A distance D5 is smaller than a distance D6. The distance D5 is, for example, 5 μm or more, and may be 10 μm or more. The distance D6 is, for example, 20 μm or more, and may be 30 μm or more.

### Manufacturing Method

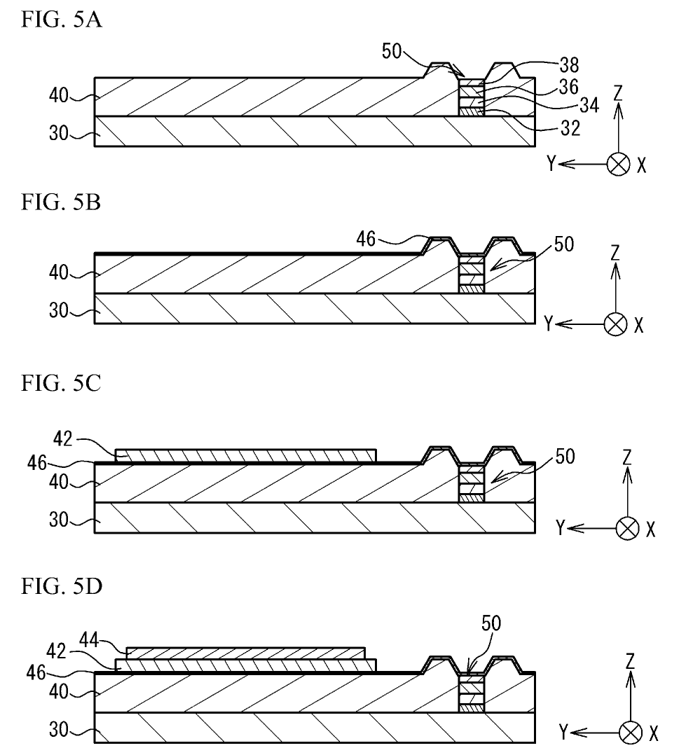

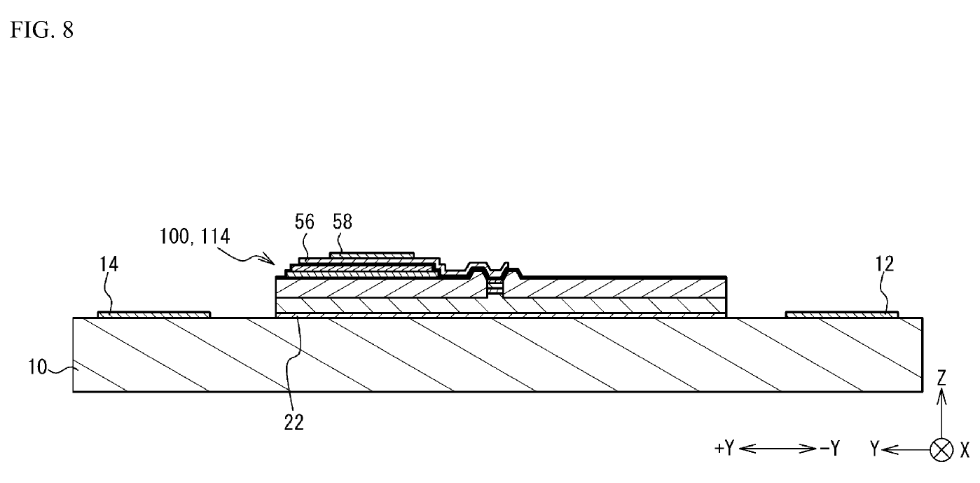

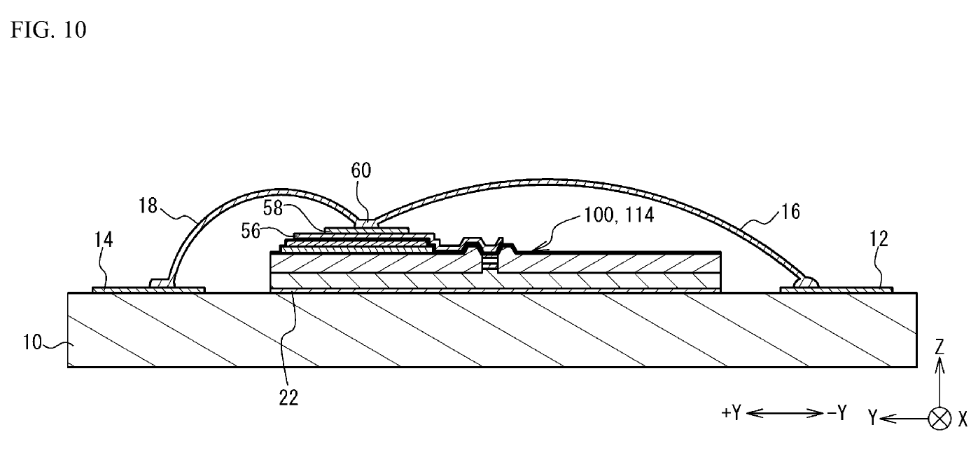

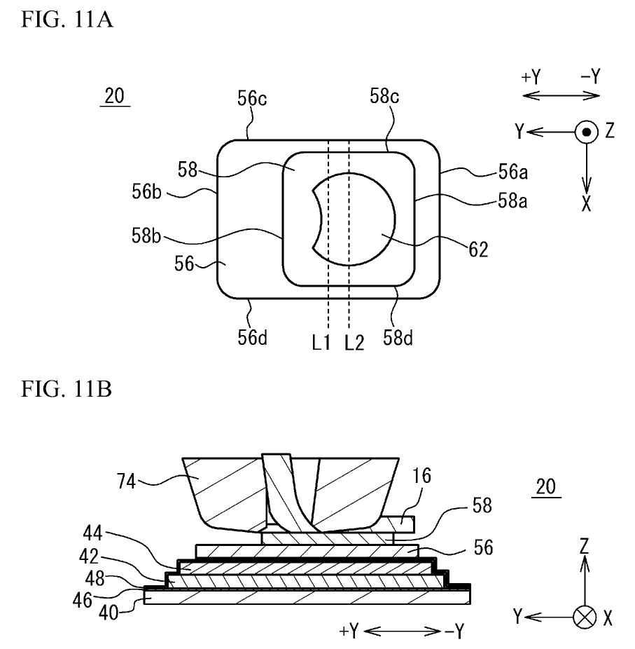

FIGS. 5A and 10 are cross-sectional views illustrating a method for manufacturing the optical semiconductor device 100. FIGS. 5A to 7E show cross-sections taken at the line A-A of FIG. 1. FIGS. 8 to 10 show the wire bonding process.

As illustrated in FIG. 5A, by using metal-organic chemical vapor deposition (MOCVD) or the like, the cladding layer 32, the light absorption layer 34, the cladding layer 36, and the contact layer 38 are sequentially epitaxially grown on one surface of the substrate 30. The mesa 50 is formed by etching. The embedding layer 40 is epitaxially grown on both sides of the mesa 50.

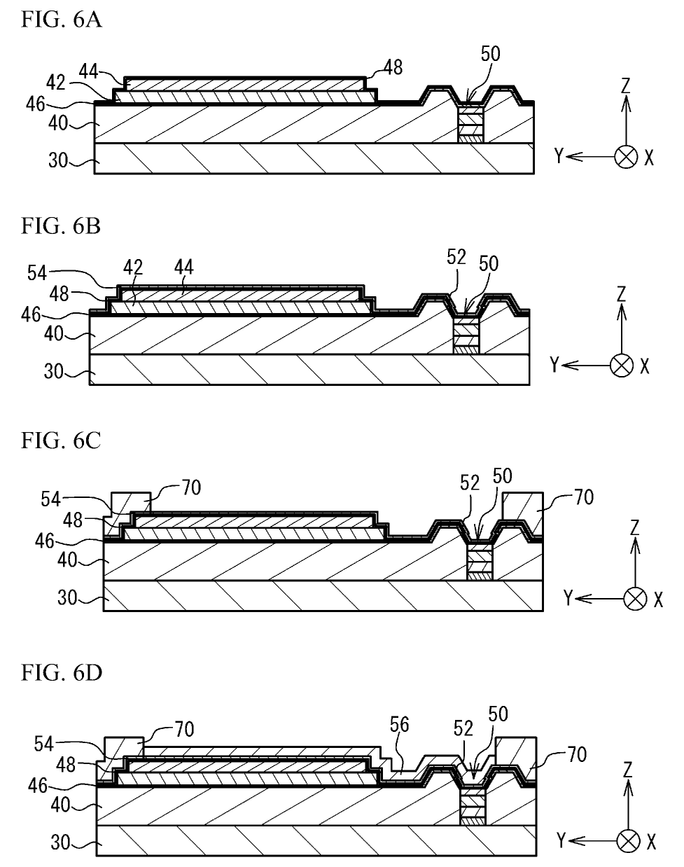

As illustrated in FIG. 5B, the insulating film 46 is formed by, for example, plasma enhanced CVD (PECVD). As illustrated in FIG. 5C, the resin layer 42 is formed on the insulating film 46. As illustrated in FIG. 5D, the resin layer 44 is formed on the resin layer 42. As illustrated in FIG. 6A, the insulating film 48 is formed by, for example, PECVD. The insulating film 48 covers the resin layer 44, the insulating film 46, and the upper surface of the mesa 50.

As illustrated in FIG. 6B, an opening is formed in a portion of the insulating film 48 covering the mesa 50. The adhesion layer 52 is formed in the opening. The seed metal layer 54 is formed on the upper surfaces of the adhesion layer 52 and the insulating film 48. The seed metal layer 54 extends from the mesa 50, over the embedding layer 40, and over the resin layers 44 and 42.

As illustrated in FIG. 6C, a photoresist 70 is provided and resist patterning is performed. The photoresist 70 is located on both sides of the mesa 50 and extends over a part of the resin layer 42 and a part of the resin layer 44. The portion including the mesa 50 is exposed from the photoresist 70. As illustrated in FIG. 6D, the metal layer 56 is formed on the portion exposed from the photoresist 70 by an electrolytic plating process using the seed metal layer 54 as a power supply line.

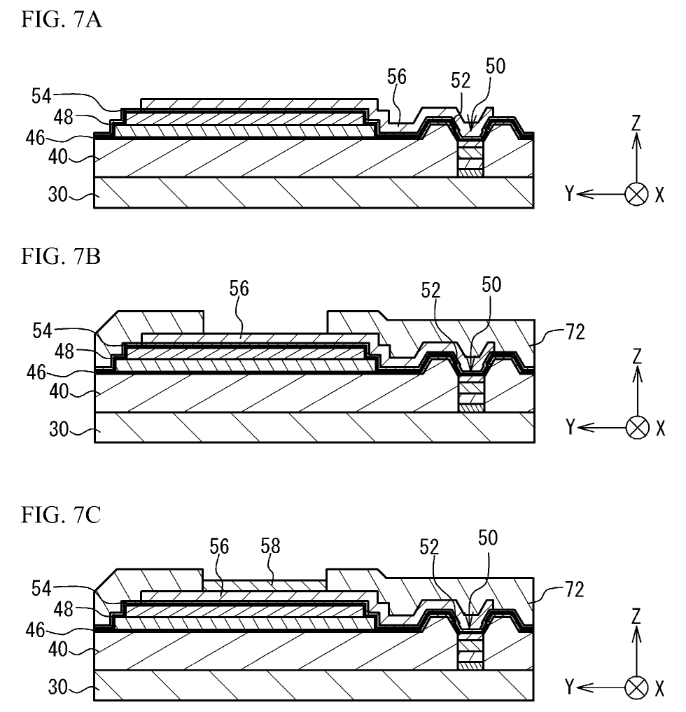

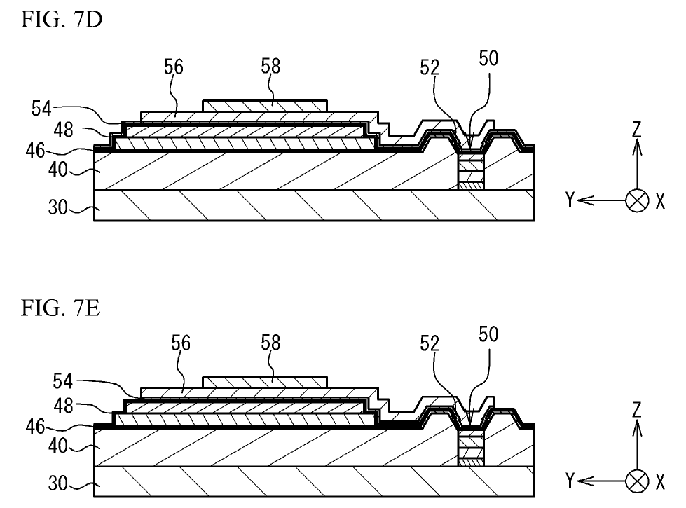

As illustrated in FIG. 7A, the photoresist 70 is removed. As illustrated in FIG. 7B, a photoresist 72 is formed and resist patterning is performed. The photoresist 72 covers the mesa 50. A part of the metal layer 56 is exposed from the photoresist 72. As illustrated in FIG. 7C, the metal layer 58 is formed on a portion of the metal layer 56 exposed from the photoresist 72 by plating. In the resist patterning, the opening of the photoresist 72 is formed at a position shifted to the negative Y side from the center of the metal layer 56 (see FIG. 2A). The metal layer 58 is also offset from the center of the metal layer 56. As illustrated in FIG. 7D, the photoresist 72 is removed. As illustrated in FIG. 7E, a portion of the seed metal layer 54 exposed from the metal layer 56 is removed. In a process not illustrated, the electrode 22 is formed on the back surface of the substrate 30. The optical modulator 114 is formed by the above processes. The laser unit 112 is formed by MOCVD, etching, and the like.

As illustrated in FIG. 8, the semiconductor element 110 is mounted on the substrate 10. The electrode 22 of the semiconductor element 110 is in contact with the upper surface of the substrate 10. The pad 12 is located in the negative Y direction with respect to the semiconductor element 110. The pad 14 is located in the positive Y direction with respect to the semiconductor element 110.

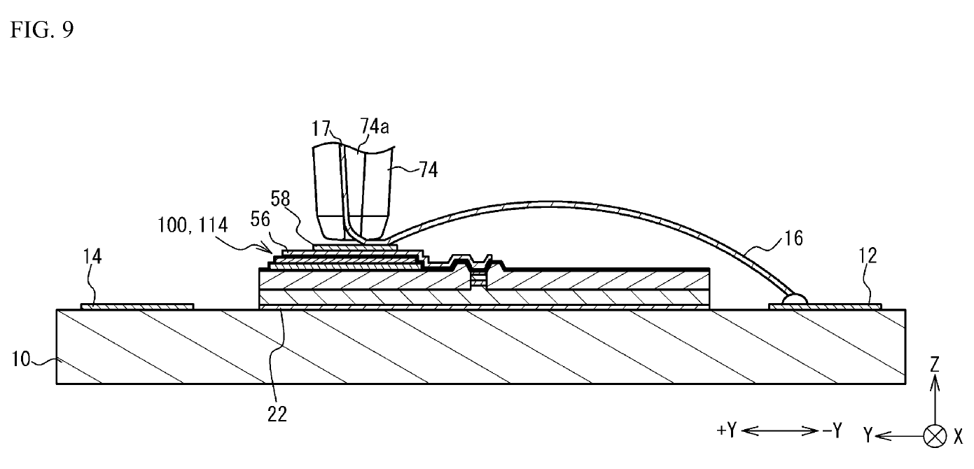

As illustrated in FIGS. 9 and 10, the bonding process is performed consecutively to connect the bonding wire 16 and subsequently connect the bonding wire 18. Stitch bonding is performed using a pressure bonding tool 74. Heat, ultrasonic vibration, and load are applied from the pressure bonding tool 74 to bond the bonding wire. A cross-section of the pressure bonding tool 74 is illustrated in FIG. 9. A bonding wire 17 is supplied from the outside of the pressure bonding tool 74 to the gap of an inner diameter 74a and passes through the gap.

As illustrated in FIG. 9, the bonding wire 16 is bonded to the surface of the pad 12, and the pressure bonding tool 74 is moved in the Y-axis direction and the Z-axis direction to extend the bonding wire 16 to the metal layer 58. The bonding wire 16 is bonded to the surface of the metal layer 58.

As illustrated in FIG. 10, the pressure bonding tool 74 is moved from the metal layer 58 to the pad 14, and the bonding wire 18 is extended from the metal layer 58 to the pad 14. The bonding wire 18 is bonded to the surface of the pad 14.

FIG. 11A is a plan view illustrating a bonding process. FIG. 11B is a cross-sectional view illustrating a bonding process. FIGS. 11A and 11B illustrate a process enlarging the electrode pad 20 and bonding a bonding wire to the electrode pad 20. As illustrated in FIG. 11A and 11B, the bonding wire 16 is pressed and bonded, aiming at the center L2 of the metal layer 58 in the Y-axis direction. The metal layer 58 is shifted in the negative Y direction with respect to the center L1 of the metal layer 56. The connection region 62 is located at the center L2 of the metal layer 58 and is offset in the negative Y direction with respect to the center L1 of the metal layer 56.

According to the first embodiment, the pad 12 is provided in the negative Y direction with respect to the optical modulator 114. The pad 14 is provided in the positive Y direction with respect to the optical modulator 114. The bonding wire 16 is connected to the electrode pad 20 of the optical modulator 114 and the pad 12. The bonding wire 18 is connected to the electrode pad 20 and the pad 14.

The wire bonding process is performed continuously. The bonding is performed in the order of the pad 12, the electrode pad 20, and the pad 14. As illustrated in FIGS. 9 and 10, in the bonding process, after the bonding wire 16 is bonded to the surface of the electrode pad 20, the bonding wire 18 is stretched in the Z-axis direction and the Y-axis direction. At this time, an upward force is applied to the electrode pad 20. This is because the bonding wire 17 is pulled upward by friction between the surface of the inner diameter 74a and the bonding wire 17 when the bonding wire 17 penetrating the inner diameter 74a of the pressure bonding tool 74 is stretched in the Z-axis direction and the Y-axis direction. However, as illustrated in FIG. 4A, the connection region 62 of the electrode pad 20 with the bonding wire is offset toward the pad 12, and is closer to the end 56a of the electrode pad 20 on the pad 12 side than to the end 56b of the electrode pad 20 on the pad 14 side. This increases the strength of the electrode pad 20 and makes the electrode pad 20 less likely to peel off. To improve strength, it is not necessary to enlarge the electrode pad 20. The capacitance is reduced by the electrode pad 20 being small. The operation speed of the optical modulator 114 is improved.

The electrode pad 20 includes the metal layer 56 and the metal layer 58. A bonding wire is bonded to the surface of the metal layer 58, and the connection region 62 is formed. In the wire bonding process, an upward force is applied to the metal layer 58 and the metal layer 56. Since the connection region 62 is close to the end 56a on the pad 12 side, the strength of the electrode pad 20 increases. The metal layer 56 and the metal layer 58 are less likely to peel off. In the embodiment, the bonding wire is connected to the center of the metal layer 58, but the metal layer 56 and the metal layer 58 are bonded to each other by metals, and thus have higher strength than the bonding between the insulating film and the metal layer. Thus, even when bonding is performed at the center of the metal layer 58, peeling is less likely to occur. It is noted that, an electric signal is input to the stripe electrode 53 through the electrode pad 20. A potential is provided to the light absorption layer 34, and light is modulated. Since the electrode pad 20 is not easily peeled off, the optical modulator 114 operates stably.

As illustrated in FIG. 4A, the metal layer 58 is stacked on a surface of the metal layer 56 at a position shifted in the negative Y direction. The distance D1 between the end 58a of the metal layer 58 to the end 56a of the metal layer 56 is shorter than the distance D2 between the end 58b to the end 56b. The metal layer 56 is less likely to peel off. In the example of FIG. 4A, the center of one side of the metal layer 58 extending in the Y direction is shifted to a position closer to one end of the substrate 10 on the negative Y side than the center of one side of the metal layer 56 extending in the Y direction. The wire bonding is performed in order from the negative Y side to the positive Y side. The center of one side of the metal layer 58 extending in the Y direction may be shifted to a position farther from the one end of the substrate 10 on the negative Y side than the center of one side of the metal layer 56 extending in the Y direction. In this case, the wire bonding is performed in the order from the positive Y side to the negative Y side.

The metal layer 58 is stacked at a position shifted in the negative Y direction on the surface of the metal layer 56. To offset the connection region 62 in the negative Y direction, the bonding wire 16 may be bonded to, for example, the center of the metal layer 58, using the metal layer 58 as a marker for alignment. The connection region 62 is located near the center of the metal layer 58, far from the end 56b of the metal layer 56, and near the end 56a. Alignment is facilitated in the bonding process, and the strength of the electrode pad 20 may be enhanced.

The bonding wire is connected to the electrode pad 20 and the pad by, for example, stitch bonding, and is in contact with these surfaces. As illustrated in FIG. 3B, the ball 60 is formed after the connection, and the ball 60 is fixed to the surface of the electrode pad 20. When extending the bonding wire 18, force is applied to the electrode pad 20. Since the ball 60 is formed near the end 56a, the electrode pad 20 is not easily peeled off. Note that, due to the stitch bonding, the ball 60 of FIG. 4A has a recess in the positive Y direction, and forms an asymmetric shape.

When the connection region 62 is located at a position shifted in the negative Y direction, the distance D5 between the end of the connection region 62 to the end 56a of the electrode pad 20 is reduced. As described in the second embodiment, when the distance D5 is too small, the electrode pad 20 may peel off. The distance D5 between the end of the connection region 62 to the end 56a of the electrode pad 20 is, for example, 5 μm or more. The distance D6 between the end of the connection region 62 to the end 56b of the electrode pad 20 is, for example, 20 μm or more. Since the strength is increased, the electrode pad 20 is less likely to peel off.

By enlarging the electrode pad 20, the distance D5 and the distance D6 may be set to appropriate sizes. However, the capacitance is increased. By downsizing the electrode pad 20, the capacitance is reduced, and the operation speed of the optical modulator 114 is improved. The width W1 and the width W3 of the electrode pad 20 are set to, for example, 100 μm or less. The capacitance is reduced, and the distance D5 and the distance D6 may be maintained. The width W1 and the W3 of the electrode pad 20 may be, for example, 100 μm or less, 120 μm or less, 150 μm or less, or 200 μm or less.

The metal layer 58 and the metal layer 56 are in contact with each other, and thus have high adhesion. The metal layer 58 is not easily peeled off from the metal layer 56. The embedding layer 40 of the optical modulator 114 is covered with the insulating film 48. The electrode pad 20 is provided on the insulating film 48. The adhesion between the metal layer 58 and the insulating film 48 such as SiN is lower than the adhesion between metals. According to the first embodiment, the metal layer 56 is less likely to peel off from the insulating film 48 due to the increased strength.

The Y-axis direction is a direction traversing the optical modulator 114. As illustrated in FIG. 1, the pad 12, the electrode pad 20, and the pad 14 are aligned in a straight line in the Y-axis direction. The bonding wire 16 extends in the Y-axis direction and is connected to the pad 12 and the electrode pad 20. The bonding wire 18 extends in the Y-axis direction and is connected to the electrode pad 20 and the pad 14. The bonding wires are bonded to the pad 12, the electrode pad 20, and the pad 14 in this order. When the bonding wire 18 is extended from the electrode pad 20 to the pad 14, an upward force is applied to the electrode pad 20. Since the strength of the electrode pad 20 is increased, the electrode pad 20 is less likely to peel off.

### Second Embodiment

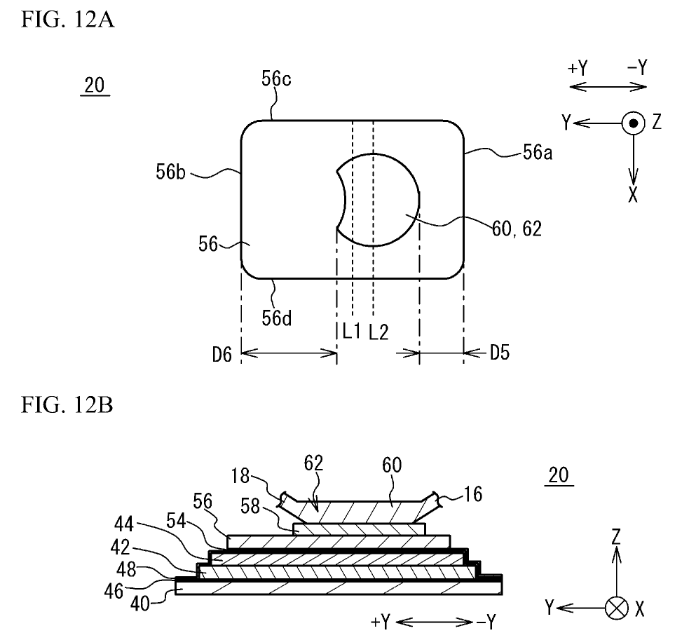

FIG. 12A is a plan view illustrating the electrode pad 20 of an optical semiconductor device according to a second embodiment. FIG. 12B is a cross-sectional view illustrating the electrode pad 20. The description of the same configuration as that of the first embodiment will be omitted.

The electrode pad 20 is formed of the metal layer 56. The bonding wire is connected to the surface of the metal layer 56. The connection region 62 is formed on the surface of the metal layer 56 at a position offset in the negative Y direction. The connection region 62 is closer to the end 56a than to the end 56b. The distance D5 between the connection region 62 and the end 56a is greater than the distance D6 between the connection region 62 and the end 56b.

Evaluation of strength will be described. While changing the connection region 62, the bonding wire is connected to the pad 12, the electrode pad 20, and the pad 14, and the strength of the bonding wire is measured. For each position, it is being verified whether the electrode pad 20 peeled off.

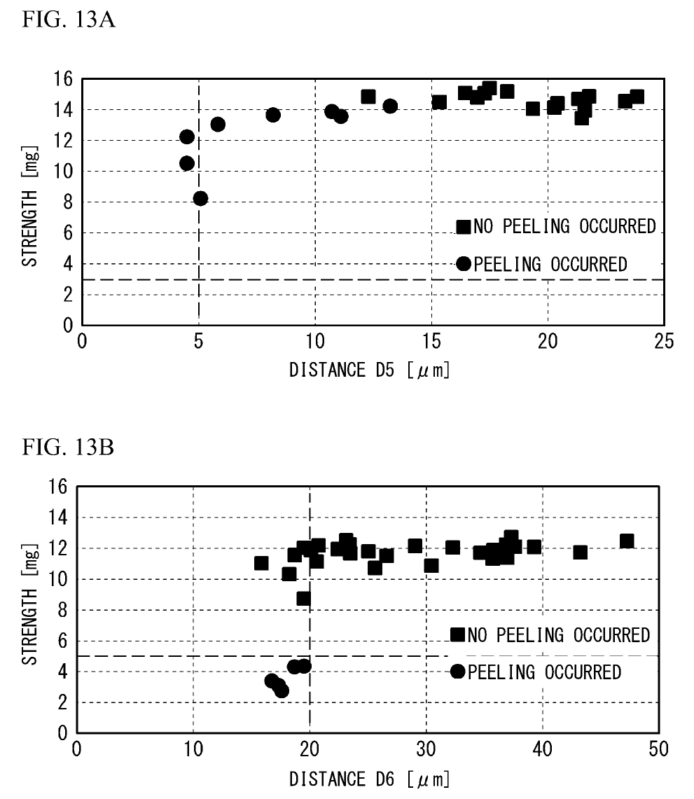

FIGS. 13A and 13B are diagrams illustrating evaluation results. The horizontal axis of FIG. 13A represents the distance D5. The vertical axis represents strength. The horizontal axis of FIG. 13B represents the distance D6. The vertical axis represents the strength of the bonding wire. The circles in the figure represent samples where peeling occurred. The squares in the figure represent samples that did not peel off.

As illustrated in FIG. 13A, the longer the distance D5 is, the less likely the electrode pad 20 is to peel off. When the distance D5 is 15 μm or more, the electrode pad 20 is not peeled off. Even when the strength of the bonding wire is set to be 12 mg or more, no peeling occurs. Peeling occurs when the strength is 8 mg or more and the distance D5 is 15 μm or less. Especially when the distance D5 is 5 μm or less, peeling occurs even when the strength is 12 mg or less. Thus, the distance D5 may be, for example, 5 μm or more, 10 μm or more, or 15 μm or more.

As illustrated in FIG. 13B, when the distance D6 is 20 μm or more, the electrode pad 20 is not peeled off. When the distance D6 is 20 μm or less, peeling may occur even at a strength of 5 mg. Thus, the distance D6 may be, for example, 20 μm or more, 25 μm or more, or 30 μm or more.

According to the second embodiment, the connection region 62 is closer to the end 56a on the pad 12 side than to the end 56b on the pad 14 side of the electrode pad 20. This increases the strength of the electrode pad 20 and makes the electrode pad 20 less likely to peel off.

The distance D5 between the connection region 62 and the end 56a is set to be, for example, 5 μm or more, 10 μm or more, or 15 μm or more. The distance D6 between the connection region 62 and the end 56b is set to be, for example, 20 μm or more, 25 μm or more, or 30 μm or more. The electrode pad 20 is hardly peeled off.

### Third Embodiment

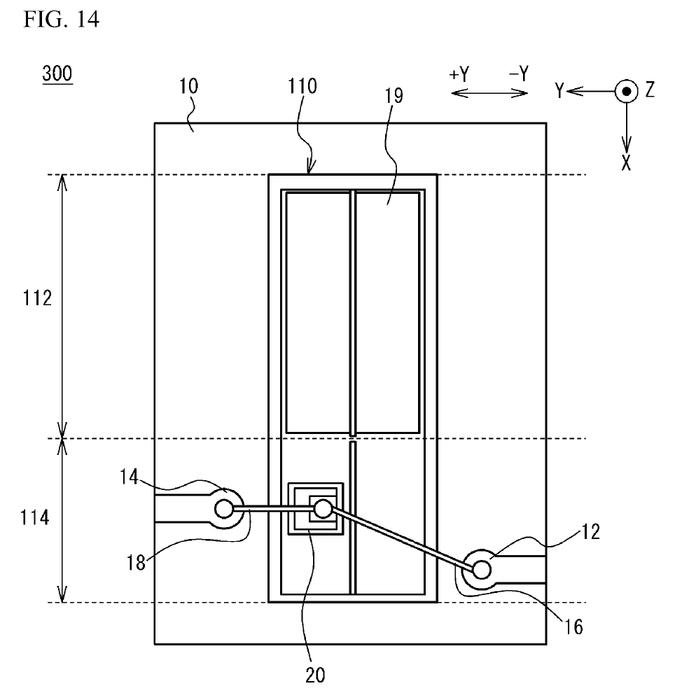

FIG. 14 is a plan view illustrating an optical semiconductor device 300 according to a third embodiment. The description of the same configuration as that of a first embodiment or a second embodiment will be omitted. As illustrated in FIG. 14, the electrode pad 20 and the pad 14 are arranged in a Y-axis direction. The pad 12 is spaced apart from the electrode pad 20 in a negative Y direction and is shifted in an X-axis direction with respect to the electrode pad 20. The bonding wire 16 extends in the X-axis direction and the Y-axis direction from the pad 12 toward the electrode pad 20 in an XY plane. The bonding wire 18 extends from the electrode pad 20 toward the pad 14 in the Y-axis direction. In a YZ plane, the bonding wires 16 and 18 have a curved shape as illustrated in FIG. 2.

According to the third embodiment, the connection region 62 is closer to the end 56a on the pad 12 side than to the end 56b on the pad 14 side of the electrode pad 20. This increases the strength of the electrode pad 20 and makes the electrode pad 20 less likely to peel off.

### Fourth Embodiment

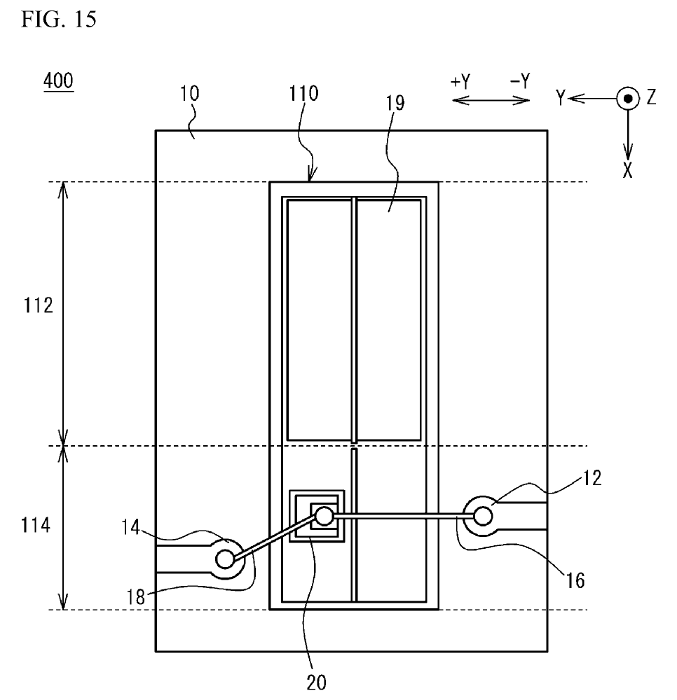

FIG. 15 is a plan view illustrating an optical semiconductor device 400 according to a fourth embodiment. The description of the same configuration as that of any of a first embodiment to a third embodiment will be omitted. As illustrated in FIG. 15, the electrode pad 20 and the pad 12 are arranged in a Y-axis direction. The pad 14 is spaced apart from the electrode pad 20 in a positive Y direction and is shifted in an X-axis direction with respect to the electrode pad 20. The bonding wire 18 extends in the X-axis direction and the Y-axis direction from the electrode pad 20 toward the pad 14 in an XY plane. The bonding wire 16 extends from the pad 12 toward the electrode pad 20 in the Y-axis direction. In a YZ plane, the bonding wires 16 and 18 have a curved shape as illustrated in FIG. 2.

According to the fourth embodiment, the connection region 62 is closer to the end 56a on the pad 12 side than to the end 56b on the pad 14 side of the electrode pad 20. This increases the strength of the electrode pad 20 and makes the electrode pad 20 less likely to peel off. As illustrated in FIG. 1, the pad 12, the electrode pad 20, and the pad 14 may be aligned in a straight line along the Y-axis direction. In the XY plane, the bonding wire 16 and the bonding wire 18 extend in the Y-axis direction. As illustrated in FIGS. 14 and 15, the pad 12, the electrode pad 20, and the pad 14 may be arranged in the Y-axis direction, and the pad may be shifted from the electrode pad 20 in the X-axis direction. The bonding wire extends in the X-axis direction and the Y-axis direction. It is sufficient that the pads 12, the electrode pad 20, and the pad 14 are aligned in the Y-axis direction, and that the bonding wire has a component in the Y-axis direction. By bringing the connection region 62 closer to the pad 12 side within the surface of the electrode pad 20, the strength of the electrode pad 20 may be increased.

Although the embodiments of the present disclosure have been described in detail, the present disclosure is not limited to the specific embodiments, and various modifications and changes can be made within the scope of the gist of the present disclosure described in the claims.

What is claimed is:

1. An optical semiconductor device, comprising:
an optical modulator having an electrode pad;
a first pad spaced apart from the optical modulator;
a second pad spaced apart from the optical modulator and provided opposite to the first pad with respect to the optical modulator; and
a bonding wire connected from the first pad to the electrode pad and continuously connected from the electrode pad to the second pad,
wherein the bonding wire is in contact with a surface of the electrode pad in a connection region on the surface of the electrode pad, and
wherein the connection region is disposed closer to an end of the electrode pad near the first pad than to an end of the electrode pad near the second pad.

2. The optical semiconductor device according to claim 1,
wherein the electrode pad is provided on a semiconductor substrate and includes a first metal layer and a second metal layer,
wherein the second metal layer is stacked on a surface of the first metal layer,
wherein a center of one side of the second metal layer is shifted either closer to or farther from one end of the semiconductor substrate than a center of one side of the first metal layer, and
wherein the connection region is disposed on a surface of the second metal layer.

3. The optical semiconductor device according to claim 2, wherein
a distance between an end of the second metal layer closer to the first pad and an end of the first metal layer closer to the first pad is shorter than a distance between an end of the second metal layer closer to the second pad and an end of the first metal layer closer to the second pad.

4. The optical semiconductor device according to claim 1, wherein
the optical modulator includes a light absorption layer that absorbs an input light in response to being provided with a potential, and a stripe electrode that is connected to the electrode pad, is provided between the electrode pad and the first pad, and provides the potential to the light absorption layer.

5. A semiconductor element, comprising:
a semiconductor substrate;
a first electrode pad provided on the semiconductor substrate; and
a second electrode pad provided on the first electrode pad, the second electrode pad having one side shorter than one side of the first electrode pad,
wherein a center of the one side of the second electrode pad is shifted either closer to or farther from one end of the semiconductor substrate than a center of the one side of the first electrode pad.

6. A method for manufacturing an optical semiconductor device, comprising:
connecting a first bonding wire to an electrode pad of an optical modulator and a first pad spaced apart from the optical modulator; and
after the connecting the first bonding wire, connecting a second bonding wire to the electrode pad and a second pad, the second pad being spaced apart from the optical modulator and being provided opposite to the first pad with respect to the optical modulator,
wherein the connecting the first bonding wire and the connecting the second bonding wire are performed continuously,
wherein each of the first bonding wire and the second bonding wire is bonded to a connection region on a surface of the electrode pad with a pressure bonding tool and is in contact with the connection region, and
wherein the connection region is closer to an end of the electrode pad near the first pad than to an end of the electrode pad near the second pad.

7. The method for manufacturing an optical semiconductor device according to claim 6, wherein
each of the connecting the first bonding wire and the connecting the second bonding wire includes connecting by stitch bonding.
